(19) United States
(12) Patent Application Publication
(10) Pub. No.: US 2006/0180113 A1
(43) Pub. Date: Aug. 17, 2006

(54) Combustion engine pull-starter

(75) Inventor: George M. Pattullo, Caro, MI (US)

Correspondence Address: REISING, ETHINGTON, BARNES, KISSELLE, P.C., P O BOX 4390, TROY, MI, 48099-4390, US

(73) Assignee: Walbro Engine Management, L.L.C.

(21) Appl. No.: 11/059,038

(22) Filed: Feb. 16, 2005

(51) Int. Cl. F01L 13/08; F02M 1/08; F02N 3/02

(52) U.S. Cl. 123/179.18; 123/185.3; 123/182.1

(57) ABSTRACT

A pull-starter for a combustion engine of an engine-powered apparatus having a startup element such as an engine start-assist device or an apparatus safety lock. The pull-cord is attached to and wound around a recoil pulley, and routed at least partially around a portion of a movable dampener arm, to a handle. The movable dampener arm is biased toward a rest position and a portion thereof is linked to the startup element(s). The handle of the pull-cord is manually pulled so as to displace the movable dampener arm away from its rest position, automatically actuate the at least one startup element, and unwind the pull-cord from around the recoil pulley and thereby rotate the recoil pulley in an unwind direction to rotate a crankshaft of the engine via a releasable coupling.

### FIELD OF THE INVENTION

The present invention relates generally to a combustion engine starter and more particularly to a pull-starter for an engine-powered apparatus that dampens pulling forces and may additionally automatically actuate a start element associated with the engine-powered apparatus.

### BACKGROUND OF THE INVENTION

For many decades small internal combustion engines, such as those used for recreational vehicles and landscaping tools like chain saws, trimmers, tractors, and lawn mowers, have typically used mechanical, manually-operated recoil pull-starters. In a direct recoil pull-starter, an operator of the vehicle or garden tool pulls a cord which is wound about a recoil pulley to rotate the recoil pulley in a first direction. The rotating recoil pulley rotates an engine crankshaft, via a one-way coupling, to start a combustion engine. The one-way coupling allows the crankshaft of the running engine to rotate freely relative to the recoil pulley. When the cord is released by the operator, the recoil pulley automatically reverses rotation, by way of a torsional recoil spring, to retract the cord back around the recoil pulley.

The direct recoil pull-starter is generally satisfactory, but in some applications, may be disadvantageous. In the event that an engine was shut down with the piston before top dead center and with the exhaust and intake valves closed (i.e. during a compression stroke of the engine), pulling of the starter cord may be difficult to say the least. In fact, the cord may actually snap out of an operator's hand back into the pulley housing because the trapped air within the combustion chamber resists compression, essentially keeping the piston and crankshaft in their arbitrarily shutdown positions. The operator must exert a sufficiently large pulling force to overcome such internal resistance during a compression stroke of a piston in the engine.

Making matters more difficult, engine emissions regulations are becoming more stringent, thereby forcing engine manufacturers to increase the compression ratio of their engines to increase power and improve the emissions-to-power ratio. But higher compression ratios yield higher compression forces that must be overcome to start the engine, thereby making such engines relatively more difficult to start by hand. And higher compression ratios also exacerbate the problem of piston bounce between compression strokes during starting, wherein the operator experiences a jerking motion in the pull cord that gets transmitted through the piston, crankshaft, flywheel, coupling, and the pulley to which the cord is attached. Such problems are intensified with engines that have neither a relatively large weighted flywheel nor a slip clutch between an output shaft of the engine and a load.

To alleviate such conditions, many devices use a so-called stored energy recoil spring starter wherein an operator repeatedly pulls a cord, which is wound about a recoil pulley, to rotate the recoil pulley in a wind up direction to progressively wind up a ratchet engaged starter spring. When released by pressing a ratchet release button and release mechanism, the starter spring suddenly unwinds to rotate the recoil pulley in a starting direction opposite the wind up direction. The rotation of the pulley causes a crankshaft to rotate, via a one-way coupling arrangement therebetween, to start the engine. Unfortunately, however, these stored energy starters often require an operator to yank repetitively on the pull cord and are often bulky and heavy in order to accommodate a sufficiently powerful starter spring to overcome the high resistances incurred when starting the engine.

In recent years, however, many manufacturers have incorporated torsional damper springs within recoil pulleys of direct recoil starters. At least one such starter includes a rotatable pulley, a cord wound around the pulley, a recoil spring to rewind the cord, a torsional damper spring coaxial with the pulley and having one end biased against a portion of the pulley and having an opposite end biased against a centrifugal ratchet provided on an engine flywheel. This opposite end of the damper spring is arranged to releasably engage with the centrifugal ratchet so as to transmit forward rotation of the pulley to the flywheel through the ratchet. With this configuration, the shock caused by the engine is absorbed by the damper spring and a rotating force from the pulley is stored by the damper spring. Unfortunately, however, this approach may require redesigning and repackaging one or more of conventional pulleys, flywheels, and coupling mechanisms therebetween. Also, this dampening mechanism is one-dimensional in that it fails to provide additional functionality besides dampening, as will be further described herein below.

### SUMMARY OF THE INVENTION

A pull-starter is adapted for use with a combustion engine that preferably has a crankshaft and a flywheel attached to the crankshaft. The pull-starter is adapted to start the combustion engine and includes a housing, a recoil pulley carried by the housing, and a torsional biasing member operatively engaged between the housing and the recoil pulley to rotatably bias the recoil pulley in a wind up direction. The pull-starter also includes a movable dampener device that is at least partially mounted to the housing and that includes a movable dampener arm, a reaction member such as a roller carried by the movable dampener arm, and a dampener biasing member operatively engaged between the housing and the movable dampener arm to bias the movable dampener arm to a rest position. The pull-starter further includes a flexible member wound about the recoil pulley and routed at least partially about the reaction member of the movable dampener device, wherein the flexible member terminates in a handle end. Pulling of the handle end of the flexible member displaces the movable dampener arm away from its rest position against the bias force of the dampener biasing member and rotates the recoil pulley in an unwind direction. Rotation of the recoil pulley is preferably imparted to the engine via a one-way coupling interposed between the flywheel and recoil pulley.

Preferably, the pull-starter is adapted for use with an engine-powered apparatus that includes a startup element, such as an engine start-assist device or an apparatus safety lock, having a linkage operatively connected therewith. Preferably, the movable dampener arm is operatively connected to the linkage and, thus, the startup element. Accordingly, the pull-starter is preferably adapted to start the combustion engine and to actuate the startup element, wherein pulling of the handle end of the flexible member displaces the movable dampener arm away from its rest position to displace the linkage and the startup element.

At least some of the objects, features and advantages that may be achieved by at least certain embodiments of the invention include providing a pull-starter that yields a smooth and gradual pulling effort for engine starting, reduces shock transmitted through a pull-cord to an operator, reduces pull-cord kickback, automatically actuates various startup elements of an engine-powered apparatus, is of relatively compact construction, simple design, low cost when mass produced, rugged, and durable, reliable, requires little to no maintenance and adjustment in use, and in service has a long useful life.

### BRIEF DESCRIPTION OF THE DRAWINGS

These and other objects, features and advantages of this invention will be apparent from the following detailed description of the preferred embodiments and best mode, appended claims, and accompanying drawings in which:

FIGS. 1A and 1B together illustrate a mechanical block diagram of a generic presently preferred embodiment of an engine-powered apparatus having a pull-starter with a movable dampener device;

FIG. 2 is a perspective view of a second presently preferred embodiment of a pull-starter having a pivotable dampener device;

FIG. 3 is a perspective view of the pull-starter of FIG. 2, showing the pivotable dampener device in its rest position;

FIG. 4 is a perspective view of the pull-starter of FIG. 2, showing the pivotable dampener device pivoted from its rest position;

FIG. 5 is a perspective view of the pull-starter of FIG. 2, showing the pivotable dampener device fully pivoted to a stop position;

FIG. 6 is a plan view of a third presently preferred embodiment of a pull-starter, showing a pivotable dampener device in a rest position;

FIG. 7 is a plan view of the pull-starter of FIG. 6, showing the pivotable dampener device fully pivoted to a stop position;

FIG. 8 is a plan view of a fourth presently preferred embodiment of a pull-starter, showing a pivotable dampener device in a rest position;

FIG. 9 is a plan view of the pull-starter of FIG. 8, showing the pivotable dampener device fully pivoted to a stop position;

FIG. 10 is a plan view of a fifth presently preferred embodiment of a pull-starter, showing a translatable dampener device in a rest position; and

FIG. 11 is a plan view of the pull-starter of FIG. 10, showing the translatable dampener device fully translated to a stop position.

### DETAILED DESCRIPTION OF THE PREFERRED EMBODIMENTS

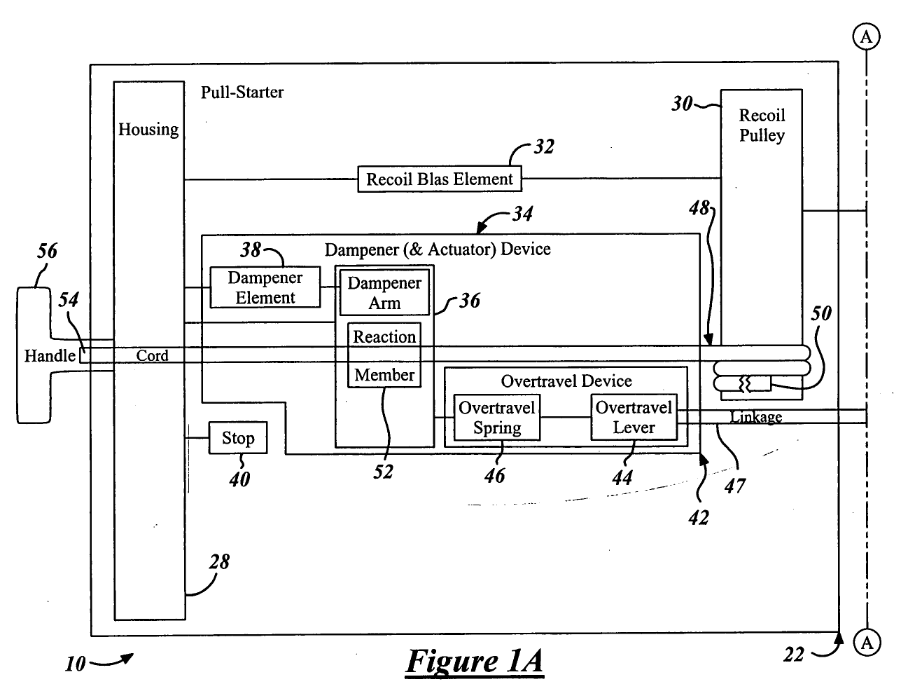

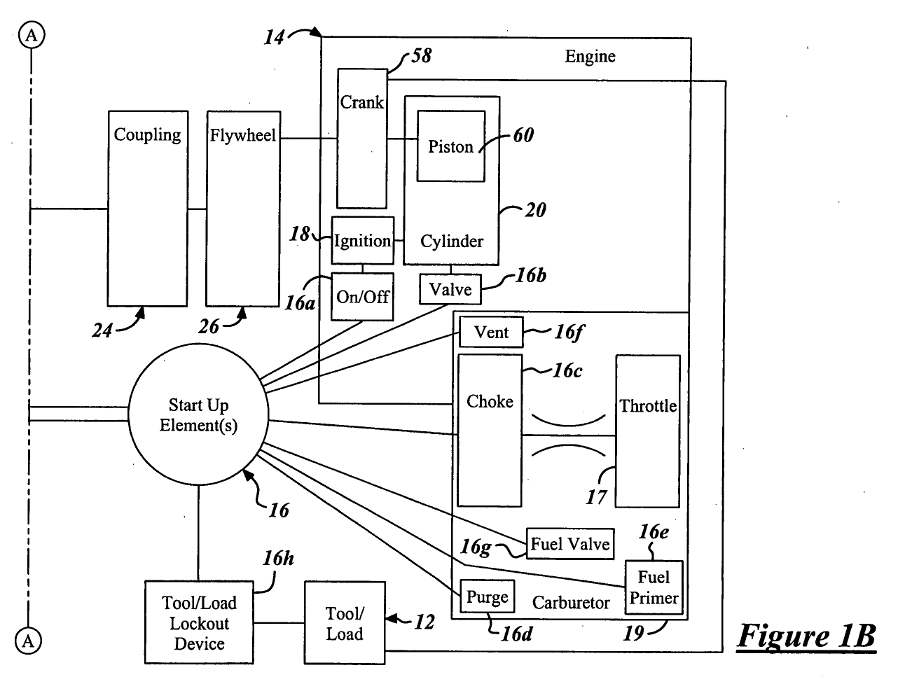

Referring in more detail to the drawings, FIGS. 1A and 1B together illustrate a mechanical block diagram of a presently preferred generic embodiment of an engine-powered apparatus 10. The apparatus 10 may be any type of desired apparatus including, but not limited to, a lawnmower, chainsaw, grass trimmer, leaf blower, tractor, a generator, all-terrain vehicle, and the like. The apparatus 10 generally includes an associated tool or load 12 to which the utility of the apparatus 10 is directed and a combustion engine 14 for powering the tool or load 12. The apparatus 10 also includes one or more of various apparatus startup element(s) 16 that will be further described herein below. Finally, the apparatus 10 also includes a pull-starter 22 for manually and mechanically pull-starting the combustion engine 14 of the apparatus 10 via a one-way coupling 24 and flywheel 26 interposed between the engine 14 and pull-starter 22. The one-way coupling 24 is preferably a centrifugally releasable coupling, which is known to those of ordinary skill in the art.

The apparatus startup element(s) 16 may include various features that, in and of themselves, are widely known to those of ordinary skill in the art. Such elements 16 may be, but are not limited to, an on/off switch 16a for controlling an engine ignition 18 to disable/enable engine operation, an engine startup-assist device like an engine decompression valve 16b for relieving pressure within an engine cylinder 20 to relieve pull-start kickback or a choke lever and valve 16c for improved cold start performance, an air purge device 16d to improve starting by removing unwanted air and stale fuel from the carburetor, a fuel primer device 16e to improve starting by injecting a predetermined amount of fuel into the intake passage of the engine, evaporative emission reduction devices like fuel vapor vent valves 16f or liquid fuel cutoff valves 16g to reduce diurnal fuel emissions, and a tool or load safety lockout device 16h, and other like features. Preferably, the start-assist device is a choke valve 16c operatively associated with a throttle valve 17 of an engine carburetor 19. Such a start-assist device is disclosed in U.S. patent application Ser. No. 10/951,149, filed on Sep. 27, 2004 by the assignee hereof and entitled “COMBUSTION ENGINE PULL-CORD START SYSTEM”, which is hereby incorporated by reference herein in its entirety. A preferred air purge/prime device start-assist device is hereby incorporated by reference herein in its entirety as disclosed in U.S. patent application Ser. No. ______, filed on Month, Date, Year by the assignee hereof and entitled “FUEL SYSTEM PURGE AND STARTER SYSTEM” having an attorney docket number of 628SC [2630.3184.001].

The pull-starter 22 is preferably a modified recoil pulley type of starter and includes a housing 28 that provides structural support for many if not all of the other starter components described herein below. As such, the starter 22 may, but need not, be a self-contained unit that mounts to the rest of the engine-powered apparatus 10. In any case, the housing 28 may be of one-piece construction or may be a sub-assembly, and is a structural member that carries a recoil sheave or pulley 30. Those of ordinary skill in the art will recognize that a recoil biasing element 32 is interposed between the recoil pulley 30 and the housing 28 to rotatably bias the recoil pulley 30 in a circumferential wind up direction. The recoil biasing element 32 is preferably a torsional spring, but any other type of component or device may be used.

The pull-starter 22 also includes a dampener device 34 that is preferably carried by the housing 28 for dampening, reducing the maximum variation of, or smoothening the pulling force required to overcome the varying resistance incurred when pull-starting the engine 14. The dampener device 34 includes a movable dampener arm 36 that is preferably movably mounted to the housing 28 and a dampener biasing member 38 that is interposed between the movable dampener arm 36 and the housing 28. The biasing member 38 may include, but is not limited to, a tension or compression spring, a tension or compression elastic member, a viscous dampener arm, and other equivalents. A dampener arm stop 40 is preferably mounted to, or is an integral part of, the housing 28 or other structural element, for limiting travel of the dampener arm 36 to a predetermined stop position.

The dampener device 34 may also be, as shown, a combination dampener and actuator device for actuating one or more of the previously discussed apparatus startup element(s) 16 as well as for dampening the pulling action required to start the engine 14. The dampener device 34 is preferably connected to one or more of the startup element(s) 16 wherein the dampener arm 36 may be directly connected to the one or more startup element(s) 16 but, as shown, is preferably indirectly connected thereto via an overtravel device 42 that provides lost-motion adjustment. The overtravel device 42 preferably includes a separate overtravel lever or arm 44 that is movably mounted to the dampener arm 36, wherein an overtravel biasing element 46 is interposed between the overtravel lever 44 and the dampener arm 36 to provide slack-free lost-motion adjustment. The overtravel biasing element 46 may be any type of spring, elastic element, viscous damper, and the like. The dampener device 34 may be connected to the startup element(s) 16 by any desired mechanical connection 47 such as solid linkage, flexible cord or cable, and the like.

Finally, the pull-starter 22 includes a flaccid or flexible member such as a pull-cord 48, cable, rope, or other such equivalent, which has a fixed end 50 attached to the recoil pulley 30. The pull-cord 48 is wound around the pulley 30, routed around or at least over a reaction portion or member 52 of the dampener arm 36, fed through the housing 28, and terminates in a handle end 54 attached to a handle 56. The reaction portion or member 52 may be a separate component such as a roller or may be an integral feature of the arm 36. The recoil biasing element 32 keeps the pull-cord 48 normally wound around the recoil pulley 50 and the pull-cord 48 pulled taut such that the handle 56 is urged against the housing 28.

In operation, an operator or user manually grasps the handle 56 attached to the pull-cord 48 and pulls the pull-cord 48 outward and away from the housing 28. The operator's pull on the pull-cord 48 rotates the pulley 30 in a circumferential unwind direction, opposite of the wind up direction, against the bias force of the recoil biasing element 32 that is engaged between the pulley 30 and the housing 28. In other words, the operator pulls the pull-cord 48 with sufficient strength to overcome the bias force of the pulley recoil biasing element 32 which would otherwise cause the pull-cord 48 to rewind back into the housing 28 over the reaction member 52 of the damper arm 36 and around the pulley 30. As the pull-cord 48 is pulled outward toward an unwound state, the recoil pulley 30 preferably engages, via the centrifugally releasable coupling 24, the flywheel 28 that is attached to a crankshaft 58 of the engine 14, thereby causing one or more piston(s) 60 to reciprocate with sufficient speed to start the engine 14. Once the engine 14 is running, the one-way coupling 24 between the flywheel 26 and recoil pulley 30 centrifugally releases so as to avoid damage to the starter 22.

The dampener device 34 cushions the high and/or varying resistance in the pull-cord 48 during pull-starting. In the case of a high compression ratio engine or in the case where the engine 14 is otherwise difficult to start because the piston 60 may be in a compression stroke in the cylinder 20 and the like, the cord 48 may be under high tension or may undergo a jerking motion that may make it difficult to properly pull-start the engine 14. Accordingly, by routing the cord 48 over the reaction member 52 of the dampener arm 36, a cushioning effect is achieved that significantly diminishes the undesirable jerking motion or initial high resistance. In other words, the dampener device 34 effectively reduces the amount of shock transmitted through the pull-cord 48 to the user by allowing “give” as the engine 14 undergoes its highest resistance at peak compression just before the piston 60 reaches top dead center within the cylinder 20 and by keeping the pull-cord 48 taut by taking up the slack in the pull-cord 48 between compression events or after the engine 14 has started and the pull-starter 22 has effectively been disengaged from the engine 14. Stated yet another way, the pull-starter 22 reduces or modulates harsh transitions in pulling resistance imparted by the engine on the pull-cord 48, both before and after engine startup.

The dampener device 34 also substantially simultaneously actuates the one or more startup element(s) 16 by virtue of the dampener arm 36 being at least indirectly connected to the startup element(s) 16. In other words, as the dampener arm 36 is displaced by the pull-cord 48 against the bias force of the dampener arm biasing member 38, the linkage 47 also moves, thereby displacing or actuating the startup element(s) 16. As the dampener arm 36 is displaced against the bias force of the biasing member 38 by the movement of the pull-cord 48, the overtravel lever 44 and biasing element 46 also move, thereby pulling the linkage 47 attached thereto and to the startup element(s) 16, to actuate the startup element(s) 16.

Preferably, the overtravel lever 44 moves relative to the dampener arm 36 over a final portion of the travel of dampener arm 36. This is particularly preferable where the actuated startup element(s) 16 reach an end-of-travel position before the dampener arm 36 hits its stop 40 to reach its end-of-travel position. In such a case, the overtravel device 44 provides slack-free lost-motion adjustment between the dampener arm 36 and the startup element(s) 16 to avoid damage to the startup element(s) 16 and/or reduce the need to maintain a precision linkage relationship therebetween. In other words, the overtravel device 42 provides a forgiving relationship between the dampener arm 36 and the startup element(s) 16.

When the engine 14 has been started and the pull-cord 48 is released by the operator, the recoil biasing element 32 causes the pulley 30 to rotate in a wind up direction through a series of complete revolutions. Because the fixed end 50 of the pull-cord 48 is engaged directly to the pulley 30, the cord 48 recoils back into the housing 28 and gets wrapped around the pulley 30 until the handle 56 seats against the housing 28. Also, the bias force of the biasing member 38 acts on the dampener arm 36 to return the dampener arm 36 to its rest position. Moreover, in the case where the dampener device 34 is attached to a startup element(s) 16, the startup element(s) 16 may have a bias member that imposes a force through the linkage 47 on the dampener arm 36 to further urge the dampener arm 36 in a direction toward its rest position.

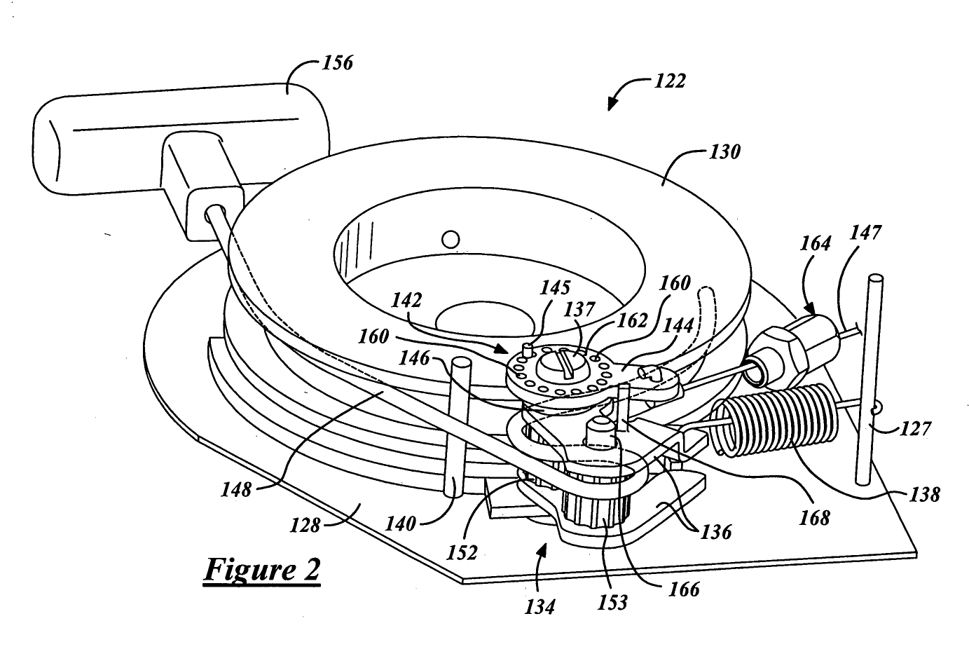

FIGS. 2 through 5 illustrate a second presently preferred embodiment of a starter 122. This embodiment is similar in many respects to the starter 22 of the embodiment of FIG. 1 and like numerals between the embodiments generally designate like or corresponding elements throughout the several views of the drawing figures. Additionally, the description of the common subject matter will generally not be repeated here.

FIG. 2 illustrates a perspective view of the pull-starter 122 that includes a housing 128 (partially shown) which is a structural member that carries a recoil pulley 130. A recoil biasing element (not shown) is interposed between the recoil pulley 130 and the housing 128 to rotatably bias the recoil pulley 130 in a circumferential wind up direction. The pull-starter 122 also includes a dampener device 134 that is also preferably carried by the housing 128.

The dampener device 134 is a combination dampener and actuator device for actuating one or more startup elements (not shown) as well as dampening the pulling action required to start an associated engine (not shown). The dampener device 134 includes a rotatable dampener arm 136 that is preferably of two-piece stamped or cast metal or durable plastic construction as shown, and is pivotably mounted to the housing 128 by a pivot screw 137, pin, shaft, or the like. The dampener device 134 also includes a biasing member 138 that is interposed between the rotatable dampener arm 136 and a post 127 extending from the housing 128. As shown, the biasing member 138 is a coiled tension spring that is attached to a portion of the dampener arm 136 and to the post 127. A dampener arm stop 140 is preferably mounted to, or is an integral part of, the housing 128 or other structural element, for limiting travel of the dampener arm 136 to a predetermined stop position.

The dampener device 134 is connected to the previously mentioned startup element(s) via an overtravel device 142 that provides lost-motion adjustment between the dampener arm 136 and the startup element(s). The overtravel device 142 includes the separate overtravel lever 144 that is preferably of stamped or cast metal or durable plastic construction and is pivotably mounted to the dampener arm 136. An overtravel biasing element or torsional spring 146 is interposed between the overtravel lever 144 and the dampener arm 136 to provide slack-free lost-motion adjustment therebetween. The overtravel biasing element 146 is preferably a torsional spring having one end 145 projecting through one of a circumferential array of calibration holes 160 provided around a hub 162 of the overtravel lever 144, and having an opposite end (not shown) engaged against a portion of the dampener arm 136. The dampener device 134 is connected to the startup element(s) by a flexible push-pull cable 147, such as a Bowden cable assembly, and is preferably equipped with an adjustment device 164 as shown. The adjustment device 164 may be mounted to any portion of the housing 128 or any other desired structural member of an engine-powered apparatus.

The pull-starter 122 also includes a pull-cord 148, which has a fixed end (not shown) attached to the recoil pulley 130. The pull-cord 148 is wound around the pulley 130, routed first over a first reaction member 152 of the dampener arm 136 and then routed over a second reaction member 153 of the dampener arm 136 to reverse direction. The reaction members 152, 153 are preferably cogged rollers composed of nylon, Delrin®, or the like. The first reaction member 152 is rotatably mounted about the pivot screw 137 between the pieces of the dampener arm 136, and the second reaction member 153 is rotatably mounted about a post 166 extending between the pieces of the dampener arm 136. Preferably, the post 166 is an integral part of one of the pieces of the dampener arm 136 and extends through the other piece of the dampener arm 136 to fix the portions of the dampener arm 136 against relative rotation therebetween. The pull-cord 148 extends from the second reaction roller 153 of the dampener device 134 and is routed through the housing 128, and terminates in a handle end (not shown) attached to a handle 156, external of the housing 128.

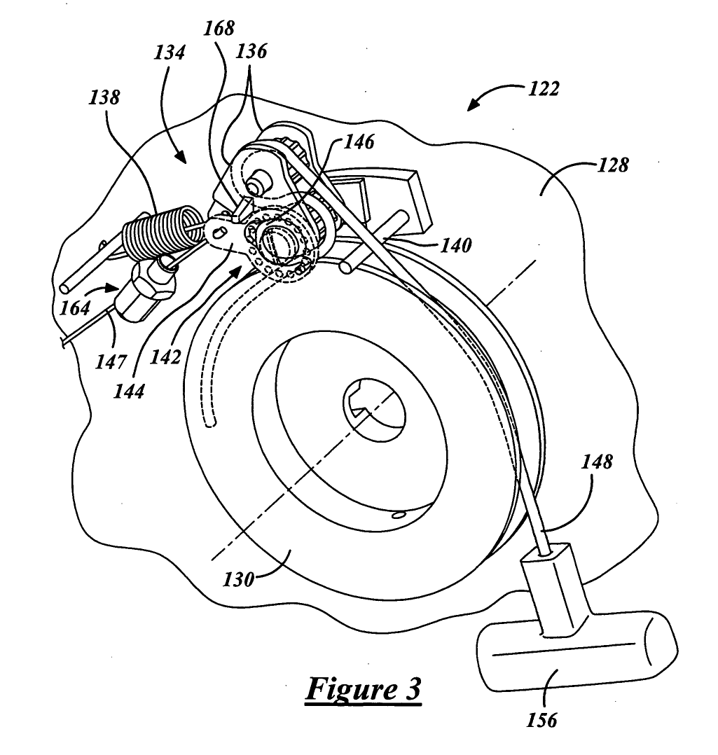

The operation of the starter is illustrated by FIGS. 3 through 5. In FIG. 3, the starter 122 is shown in a state of rest wherein the dampener spring 138 maintains the dampener arm 136 in an initial or rest position. In turn, an overtravel stop or projection 168 on the dampener arm 136 maintains the overtravel arm 144 in its initial or rest position. From this initial state of rest, an operator manually grasps the handle 156 attached to the pull-cord 148 and pulls the pull-cord 148.

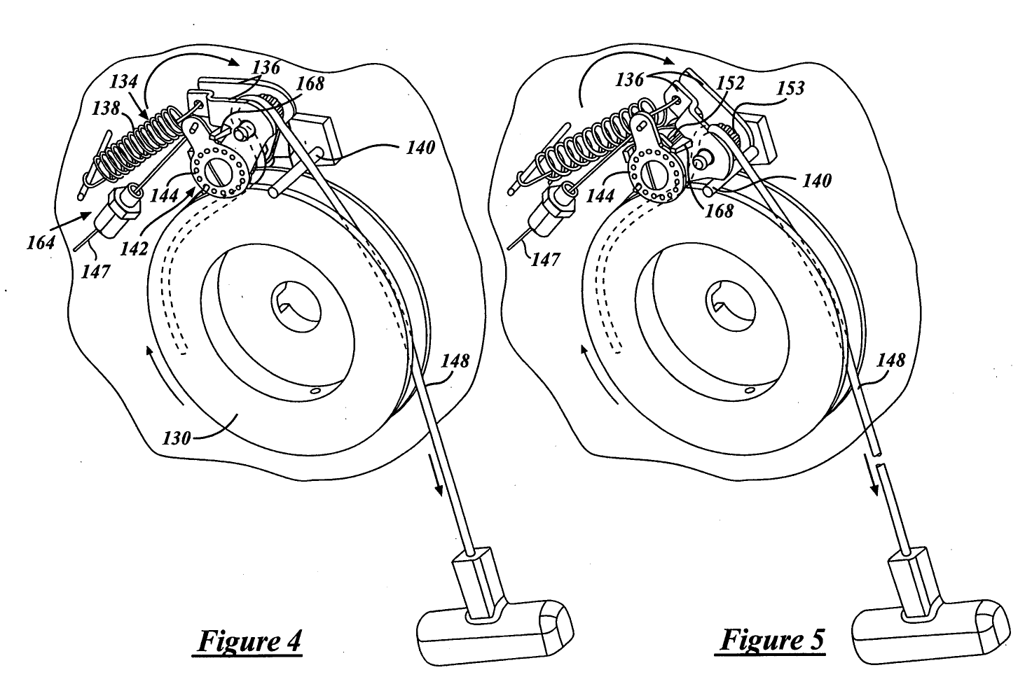

As shown in FIG. 4, under typical circumstances the pulling action on the pull cord 148 begins to pivot the dampener arm 136 of the dampener device 134 toward the stop 140 and against the bias force of the dampener spring 138 to cushion high and/or varying resistance imposed on the pull-cord 148 by the engine, and substantially simultaneously begins to rotate the pulley 130 in a circumferential unwind direction to start the engine (not shown). Moreover, the dampener device 134 also substantially simultaneously actuates the engine-powered apparatus startup element(s), when the pull cord 148 pivots the dampener arm 136, which rotates the overtravel spring 146, to thereby rotate the overtravel arm 144. Accordingly, the rotation of the overtravel arm 144 causes the push-pull cable 147 to move and, in turn, actuates the attached startup element(s).

As shown in FIG. 5, the overtravel lever 144 is movable relative to the dampener arm 136 over a final portion of the travel of dampener arm 136 to provide lost-motion adjustment between the dampener arm 136 and the startup element(s). Here, the dampener device 134 has been fully pivoted against its stop 140 and has rotated relative to the overtravel arm 144, which is no longer seated against the overtravel projection 168. Such relative movement avoids over-extension of the push-pull cable to eliminate damage to the attached startup element(s) and avoids the need to maintain an unnecessarily precise movable relationship between the dampener arm 136 and the startup element(s).

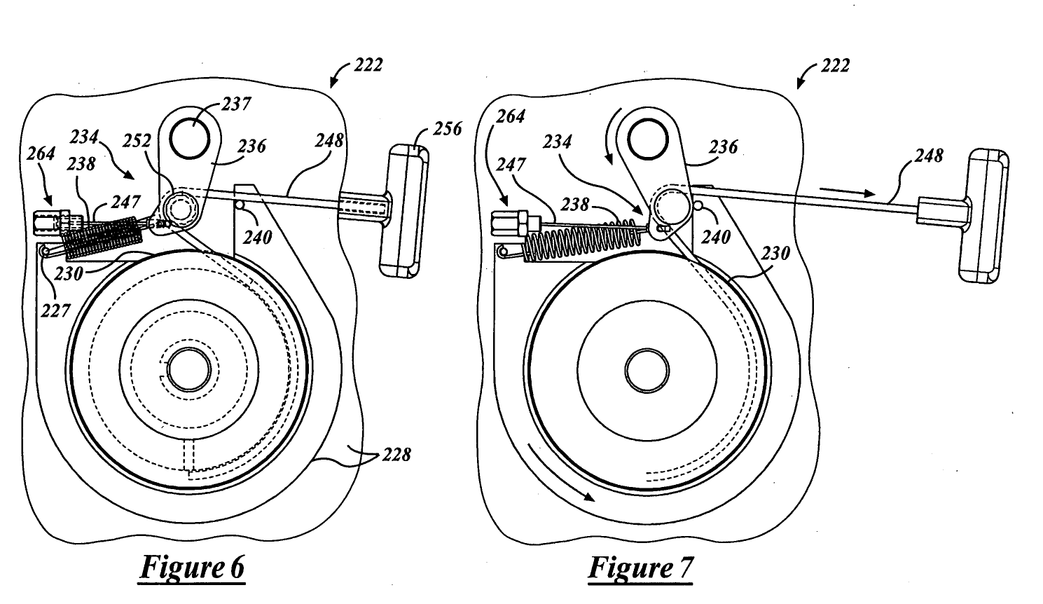

FIGS. 6 and 7 illustrate a third presently preferred embodiment of a starter 222. This embodiment is similar in many respects to the starters 22, 122 of the previous embodiments of FIGS. 1 through 5, and like numerals between the embodiments generally designate like or corresponding elements throughout the several views of the drawing figures. Additionally, the description of the common subject matter will generally not be repeated here.

FIG. 6 illustrates a plan view of the pull-starter 222 that includes a housing 228 (partially shown), which is a structural member that carries a recoil pulley 230. A recoil biasing element (not shown) is interposed between the recoil pulley 230 and the housing 228 to rotatably bias the recoil pulley 230 in a circumferential wind up direction. The pull-starter 222 also includes a dampener device 234 that is preferably carried by the housing 228.

The dampener device 234 is a combination dampener and actuator device for actuating one or more startup elements (not shown) as well as for dampening the pulling action required to start an associated engine (not shown). The dampener device 234 includes a rotatable dampener arm 236 that is preferably pivotably mounted to the housing 228 by a pivot shaft 237 through one end of the arm 236 in a location radially outboard of the outer diameter of the pulley 230. The dampener device 234 also includes a biasing member or coiled tension spring 238 that is interposed between one end of the pivotable dampener arm 236 and a post 227 extending from the housing 228. A dampener arm stop 240 is preferably mounted to, or is an integral part of, the housing 228 or other structural element, for limiting travel of the dampener arm 236 to a predetermined stop position. The dampener device 234 is connected to the previously mentioned startup element(s) through a push-pull cable 247 and adjustment device 264.

The pull-starter 222 also includes a pull-cord 248, which has a fixed end (not shown) attached to the recoil pulley 230. The pull-cord 248 is wound around the pulley 230, and routed over a reaction roller 252 of the dampener arm 236. The reaction roller 252 is rotatably mounted to the dampener arm 236 in a location between the pivot shaft 237 and the outer diameter of the pulley 230. The pull-cord 248 extends from the dampener device 234 and is routed through the housing 228, and terminates in a handle end (not shown) attached to a handle 256.

The operation of the starter 222 is illustrated by FIG. 7. Under typical circumstances, the pulling action on the pull cord 248 pivots the dampener arm 236 of the dampener device 234 toward the stop 240 against the bias force of the dampener spring 238 to cushion high and/or varying resistance imposed on the pull-cord 248 by the engine and substantially simultaneously rotates the pulley 230 in a circumferential unwind direction to start the engine (not shown). Moreover, the dampener device 234 also substantially simultaneously actuates the engine-powered apparatus startup element(s). The pull cord 248 pivots the dampener arm 236, which causes the push-pull cable 247 to move and, in turn, actuates the attached startup element(s).

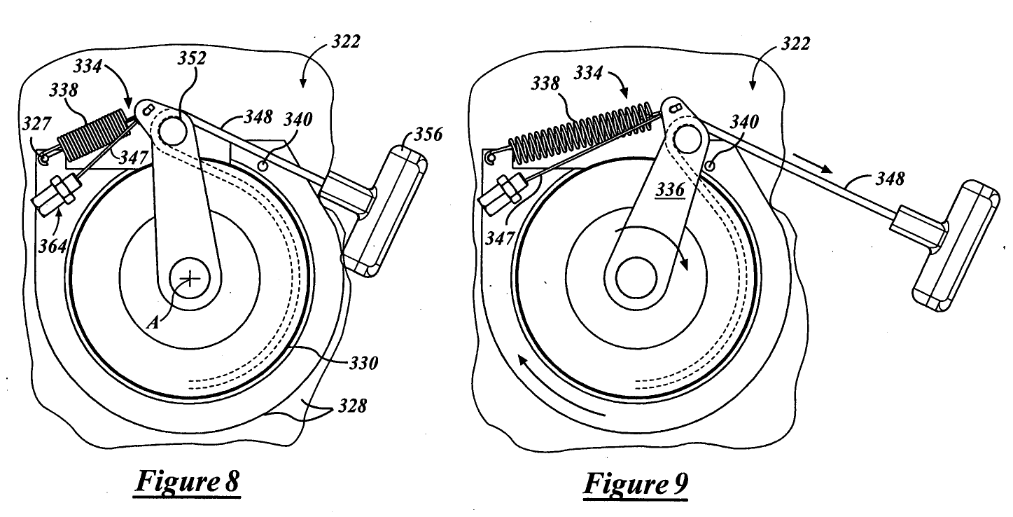

FIGS. 8 and 9 illustrate a fourth presently preferred embodiment of a starter 322. This embodiment is similar in many respects to the starters 22, 122, and 222 of the previous embodiments of FIGS. 1 through 7, and like numerals between the embodiments generally designate like or corresponding elements throughout the several views of the drawing figures. Additionally, the description of the common subject matter will generally not be repeated here.

FIG. 8 illustrates a plan view of the pull-starter 322 that includes a housing 328 (partially shown), which rotatably carries a recoil pulley 330. A recoil biasing element (not shown) is interposed between the recoil pulley 330 and the housing 328 to rotatably bias the recoil pulley 330 in a circumferential wind up direction. The pull-starter 322 also includes a dampener device 334 that is preferably carried by the housing 328.

The dampener device 334 is a combination dampener and actuator device for actuating one or more startup elements (not shown) as well as dampening the pulling action required to start an associated engine (not shown). The dampener device 334 includes a rotatable dampener arm 336 that is preferably pivotably mounted to the housing 328 by a pivot shaft 337 through one end of the arm 336 in a location substantially coaxial with a rotational axis A of the pulley 330. The dampener device 334 also includes a biasing member or coiled tension spring 338 that is interposed between one end of the pivotable dampener arm 336 and a post 327 extending from the housing 328. A dampener arm stop 340 limits travel of the dampener arm 336 to a predetermined stop position. The dampener device 334 is connected to the previously mentioned startup element(s) via a push-pull cable 347 and adjustment device 364.

The pull-starter 322 also includes a pull-cord 348, which has a fixed end (not shown) attached to the recoil pulley 330. The pull-cord 348 is wound around the pulley 330, and routed over a reaction roller 352 of the dampener arm 336. The reaction roller 352 is rotatably mounted to the dampener arm 336 radially outward of the outer diameter of the pulley 330. The pull-cord 348 extends from the dampener device 334 and is routed through the housing 328, and terminates in a handle end (not shown) attached to a handle 356.

The operation of the starter 322 is illustrated by FIG. 9. Under typical circumstances, the pulling action on the pull cord 348 pivots the dampener arm 336 of the dampener device 334 toward the stop 340 against the bias force of the dampener spring 338 and substantially simultaneously rotates the pulley 330 in a circumferential unwind direction to start the engine (not shown). Moreover, the dampener device 334 also substantially simultaneously actuates the engine-powered apparatus startup element(s). The pull cord 348 pivots the dampener arm 336, which causes the push-pull cable 347 to move and, in turn, actuates the attached startup element(s).

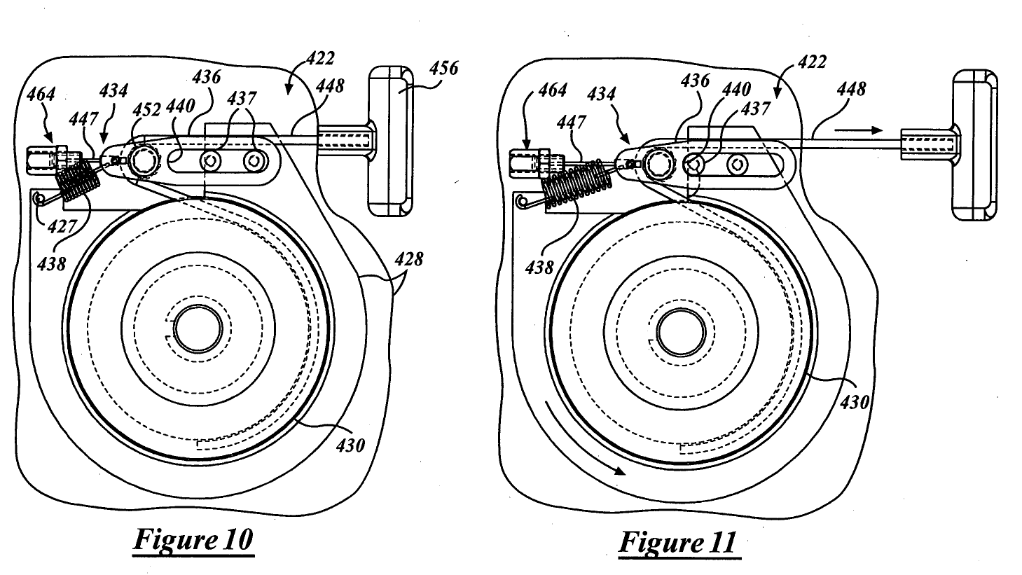

FIGS. 10 and 11 illustrate a fifth presently preferred embodiment of a starter 422. This embodiment is similar in many respects to the starters 22, 122, 222, and 322 of the previous embodiments of FIGS. 1 through 9, and like numerals between the embodiments generally designate like or corresponding elements throughout the several views of the drawing figures. Additionally, the description of the common subject matter will generally not be repeated here.

FIG. 10 illustrates a plan view of the pull-starter 422 that includes a housing 428 (partially shown) that rotatably carries a recoil pulley 430. A recoil biasing element (not shown) is interposed between the recoil pulley 430 and the housing 428 to rotatably bias the recoil pulley 430 in a circumferential wind up direction. The pull-starter 422 also includes a dampener device 434 that is preferably carried by the housing 428.

The dampener device 434 is a combination dampener and actuator device for actuating one or more startup elements (not shown) as well as dampening the pulling action required to start an associated engine (not shown). The dampener device 434 includes a linearly displaceable or translatable dampener arm 436 that is preferably mounted to the housing 428 by guide rollers 437 in a location radially outward of the outer diameter of the pulley 430. The dampener device 434 also includes a biasing member or coiled tension spring 438 that is interposed between one end of the pivotable dampener arm 436 and a post 427 extending from the housing 428. One end of a slot 440 in the dampener arm engages one of the guide rollers 437 to act as a stop for limiting travel of the dampener arm 436 to a predetermined stop position. The dampener device 434 is connected to the previously mentioned startup element(s) through a push-pull cable 447 and adjustment device 464.

The pull-starter 422 also includes a pull-cord 448, which has a fixed end (not shown) attached to the recoil pulley 430. The pull-cord 448 is wound around the pulley 430, and routed over a reaction roller 452 of the dampener arm 436. The reaction roller 452 is rotatably mounted to the dampener arm 436 in a location radially outward of the outer diameter of the pulley 430. The pull-cord 448 extends from the dampener device 434 and is routed through the housing 428, and terminates in a handle end (not shown) attached to a handle 456.

The operation of the starter 422 is illustrated by FIG. 11. Under typical circumstances, the pulling action on the pull cord 448 translates or displaces the dampener arm 436 of the dampener device 434 against the bias force of the dampener spring 438 until one end of the slot 440 engages one of the guide rollers 437, and substantially simultaneously rotates the pulley 430 in a circumferential unwind direction to start the engine (not shown). Moreover, the dampener device 434 also substantially simultaneously actuates the engine-powered apparatus startup element(s). The pull cord 448 linearly displaces the dampener arm 436, which causes the push-pull cable 447 to move and, in turn, actuates the attached startup element(s).

While the forms of the invention herein disclosed constitute presently preferred embodiments, many others are possible. It is not intended herein to mention all the possible equivalent forms or ramifications of the invention. It is understood that terms used herein are merely descriptive, rather than limiting, and that various changes may be made without departing from the spirit or scope of the invention as defined by the following claims.

1. A pull-starter adapted to start a combustion engine, comprising:
a recoil pulley;
a movable dampener device including:
at least one movable dampener arm;
at least one reaction portion; and
at least one dampener biasing member operatively engaged with the movable dampener device to bias the at least one movable dampener arm to a rest position; and
a flexible member wound about the recoil pulley and routed at least partially about the at least one reaction portion of the movable dampener device, the flexible member terminating in a handle end, wherein pulling of the handle end of the flexible member displaces the movable dampener arm away from its rest position against the bias force of the at least one dampener biasing member and rotates the recoil pulley in an unwind direction.

2. The pull-starter set forth in claim 1 further adapted for actuating at least one startup element of an engine-powered apparatus, wherein the at least one movable dampener arm of the movable dampener device is mechanically linked to the at least one startup element.

3. The pull-starter set forth in claim 1 further comprising a housing for carrying the recoil pulley and the movable dampener device, wherein the at least one dampener biasing member is a tension spring having one end attached to the housing and an opposite end attached to the at least one movable dampener arm.

4. The pull-starter set forth in claim 1 wherein the movable dampener device includes an overtravel arm movably mounted with respect to the at least one movable dampener arm, wherein an overtravel biasing member is interposed between the overtravel arm and the at least one dampener arm.

5. The pull-starter set forth in claim 1 wherein the at least one movable dampener arm is pivotable.

6. The pull-starter set forth in claim 5 wherein the at least one reaction portion of the movable dampener device includes two rollers having the flexible member at least partially wound thereabout.

7. The pull-starter set forth in claim 5 wherein the at least one reaction portion is interposed between a rotational axis of the recoil pulley and a pivot axis of the movable dampener device.

8. The pull-starter set forth in claim 5 wherein the at least one movable dampener arm is pivotably mounted about a rotational axis of the recoil pulley wherein the at least one reaction portion is positioned radially outward of the outer diameter of the recoil pulley and wherein the at least one dampener biasing member is a tension spring having a fixed end and an opposite end attached to a portion of the at least one movable dampener arm.

9. The pull-starter set forth in claim 1 wherein the at least one movable dampener arm is a translatably mounted dampener arm carrying the at least one reaction portion and further wherein the at least one dampener biasing member is a tension spring having a fixed end and an opposite end attached to a portion of the translatably mounted dampener arm.

10. An engine-powered apparatus comprising:
a combustion engine having a crankshaft;
at least one startup element having at least one linkage operatively connected therewith;
a flywheel attached to the crankshaft of the combustion engine;
a pull-starter adapted to start the combustion engine and to actuate the at least one startup element, comprising:
a housing;
a recoil pulley carried by the housing;
a torsional biasing member operatively engaged between the housing and the recoil pulley to rotatably bias the recoil pulley in a wind up direction;
a movable dampener device being at least partially mounted to the housing and including:
at least one movable dampener arm being at least indirectly operatively connected to the at least one linkage that is operatively connected to the at least one startup element;
at least one reaction member carried by the at least one movable dampener arm; and
at least one dampener biasing member operatively engaged between the housing and the at least one movable dampener arm to bias the at least one movable dampener arm to a rest position; and
a flexible member wound about the recoil pulley and routed at least partially about the at least one reaction member of the movable dampener device, the flexible member terminating in a handle end, wherein pulling of the handle end of the flexible member displaces the at least one movable dampener arm away from its rest position against the bias force of the at least one dampener biasing member and rotates the recoil pulley in an unwind direction; and
a one-way coupling interposed between the flywheel and recoil pulley of the pull-starter.

11. The engine-powered apparatus set forth in claim 10 wherein the at least one startup element includes at least one of an engine-powered apparatus lockout device, an engine startup-assist device, an evaporative emissions reduction device, and an engine on/off switch.

12. The engine-powered apparatus set forth in claim 11 wherein the engine startup-assist device includes at least one of an engine cylinder decompression valve and a carburetor choke valve, further wherein the movable dampener device drives the at least one linkage upon initial pulling of the flexible member which causes at least one of the choke valve to at least partially close and the decompression valve to open.

13. The engine-powered apparatus set forth in claim 10 wherein the movable dampener device includes an overtravel arm movably mounted with respect to the at least one movable dampener arm, wherein an overtravel biasing member is interposed between the overtravel arm and the at least one movable dampener arm.

14. The engine-powered apparatus set forth in claim 10 wherein the at least one movable dampener arm is pivotably mounted in a location radially adjacent the recoil pulley.

15. The engine-powered apparatus set forth in claim 14 wherein the at least one reaction member of the movable dampener device includes two rollers having the flexible member at least partially wound thereabout.

16. The engine-powered apparatus set forth in claim 14 wherein the at least one reaction member is interposed between a rotational axis of the recoil pulley and a pivot axis of the movable dampener device.

17. The engine-powered apparatus set forth in claim 10 wherein the at least one movable dampener arm is pivotably mounted about a rotational axis of the recoil pulley wherein the at least one reaction member is positioned radially outward of the recoil pulley and wherein the at least one dampener biasing member is a tension spring having a fixed end and an opposite end attached to a portion of the at least one movable dampener arm.

18. The engine-powered apparatus set forth in claim 10 wherein the at least one movable dampener arm is a translatably mounted dampener arm carrying the at least one reaction member and further wherein the at least one dampener biasing member is a tension spring having a fixed end and an opposite end attached to a portion of the translatably mounted dampener arm.

19. A method of starting a combustion engine of an engine-powered apparatus and of actuating at least one startup element of the engine-powered apparatus, comprising:
providing a recoil pulley;
attaching a flexible member to, and winding the flexible member around, the recoil pulley;
rotatably biasing the recoil pulley in a wind up direction to maintain the flexible member wound around the recoil pulley;
routing the flexible member from the recoil pulley, at least partially around a movable dampener arm, to a handle;
biasing the movable dampener arm toward a rest position under a bias force;
linking a portion of the movable dampener arm to the at least one startup element;
releasably coupling the recoil pulley at least indirectly to a crankshaft of the engine; and
manually pulling the flexible member from its handle end so as to move the movable dampener arm away from its rest position against the bias force to thereby actuate the at least one startup element and to unwind the flexible member from around the recoil pulley to rotate the recoil pulley in an unwind direction to thereby rotate the crankshaft of the engine.

20. The method set forth in claim 19 wherein the step of linking further comprises providing slack-free lost-motion between the movable dampener arm and the at least one startup element.

21. The method set forth in claim 19 wherein the step of biasing the movable dampener arm includes rotatably biasing the movable dampener arm.

22. The method set forth in claim 19 wherein the step of biasing the movable dampener arm includes translatably biasing the movable dampener arm.
